(19) United States
(12) Patent Application Publication
(10) Pub. No.: US 2019/0361921 A1
(43) Pub. Date: Nov. 28, 2019

(54) METHOD OF CLASSIFYING INFORMATION, AND CLASSIFICATION PROCESSOR

(71) Applicant: Fraunhofer-Gesellschaft zur Foerderung der angewandten Forschung e.V., Munich (DE)

(72) Inventors: Gesa BENNDORF, Freiburg (DE); Nicolas RÉHAULT, Freiburg (DE); Tim RIST, Freiburg (DE)

(21) Appl. No.: 16/534,947

(22) Filed: Aug. 7, 2019

Related U.S. Application Data
(63) Continuation of application No. PCT/EP2018/054709, filed on Feb. 26, 2018.

(30) Foreign Application Priority Data
Feb. 28, 2017 (EP) 17158525.0

(51) Int. Cl. G06F 16/28; G06N 20/00

(52) U.S. Cl. CPC G06F 16/285; G06N 20/00

(57) ABSTRACT

A method of classifying information into a first class or a second class different from the first class includes applying a first classification technique to the information to assign the information to the first class if the information meets classification criteria of the first class, and to assign the information to the second class if this is not the case; applying a second classification technique to the information to assign the information to the second class if the information meets classification criteria of the second class, and to assign the information to the first class if this is not the case; and updating the classification criteria of at least one of the two classification techniques if the assignments of the information that are performed by the two classification techniques deviate from each other or if a predefined number of mutually deviating assignments of information by the two classification techniques has been reached.

### CROSS-REFERENCES TO RELATED APPLICATIONS

This application is a continuation of copending International Application No. PCT/EP2018/054709, filed Feb. 26, 2018, which is incorporated herein by reference in its entirety, and additionally claims priority from European Application No. EP 17158525.0, filed Feb. 28, 2017, which is incorporated herein by reference in its entirety.

Embodiments of the present invention relate to a method of classifying information. Further embodiments relate to a classification processor for classifying information. Some embodiments relate to an error detection method.

### BACKGROUND OF THE INVENTION

Many fields of application involve the task of correctly classifying data and thus to identify, e.g., spam (in e-mail traffic), malign tumors (cancer diagnostics) or defective states of operation (technical plant) in an automated manner and to distinguish said data from “normal data”. The technical challenge is to find a technique which performs such classification as accurately as possible, i.e. which identifies as many errors as possible as such; at the same time, there should be as few erroneous classifications (mis-classifications) as errors as possible. Additionally, the difficulty consists in that the framework conditions may change, that previously unknown errors may occur and that, therefore, the technique may be adapted accordingly in the course of the application.

In principle, there is the possibility of performing such classification with the aid of expert knowledge or by means of techniques taken from machine learning. Each technique per se has specific limits and disadvantages. In particular, machine-learning techniques generally involve a large amount of high-quality training data, whereas expert systems involve a large amount of expenditure in terms of implementation and are not very flexible.

In literature, the theory of classification techniques such as support vector machine, logistic regression, Bayesian classifiers, decision trees, neuronal networks, etc. is described in detail (see, e.g., Aggarwal 2014, Han et al. 2011). Technical applications of single classifiers have been widely documented and also described in patent literature (US 2005/141782 A1 and US 2006/058898 A1). Also, combinations of various techniques are applied (US 2005/097067 A1). For the problem of spam filtering, an adaptive approach has been described (US 2004/177110 A1). In addition, meta-learning (U.S. Pat. No. 6,842,751 B1) is known.

However, the known approaches are relatively imprecise, i.e. a relatively large number of data is mis-classified. In addition, the known approaches are very slow in adapting to new or unknown data, if they adapt at all.

### SUMMARY

According to an embodiment, a computer-implemented method of classifying information into a first class or a second class may have the steps of: applying a first classification technique to the information so as to assign the information to the first class if the information meets classification criteria of the first class, and to assign the information to the second class if the information does not meet the classification criteria of the first class; applying a second classification technique to the information so as to assign the information to the second class if the information meets classification criteria of the second class, and to assign the information to the first class if the information does not meet the classification criteria of the second class; and updating the classification criteria of at least one of the two classification techniques in the event that the assignments of the information that are performed by the two classification techniques deviate from each other or in the event that a predefined number of mutually deviating assignments of information by the two classification techniques has been reached; wherein the first class and the second class differ from each another; wherein the method is used for error detection in technical plants; wherein the information classified by the method is sensor data; wherein the method may have the steps of: outputting a first signal if the information has been assigned to the first class by both classification techniques; outputting a second signal if the information has been assigned to the second class by both classification techniques; and outputting a third signal if the information has been assigned to different classes by the classification techniques.

According to another embodiment, a classification processor for classifying information into a first class or a second class may have: two parallel classification stages, a first classification stage of the two classification stages being configured to assign the information to the first class if the information meets classification criteria of the first class, and to assign the information to the second class if the information does not meet the classification criteria of the first class, a second classification stage of the two classification stages being configured to assign the information to the second class if the information meets classification criteria of the second class, and to assign the information to the first class if the information does not meet the classification criteria of the second class, the first class and the second class being different from each another; and an updating stage configured to update the classification criteria at least of one of the two classification stages in the event that the assignments of the information that are performed by the two classification stages deviate from each other or in the event that a predefined number of mutually deviating assignments of information by the two classification stages has been reached, wherein the information classified by the classification processor is sensor data; wherein the classification processor is configured to output a first signal if the information has been assigned to the first class by both classification techniques; wherein the classification processor is configured to output a second signal if the information has been assigned to the second class by both classification techniques; and wherein the classification processor is configured to output a third signal if the information has been assigned to different classes by both classification techniques.

Embodiments provide a method of classifying information into a first class or a second class. The method includes a step of applying a first classification technique to the information so as to assign the information to the first class if the information meets classification criteria of the first class, and to assign the information to the second class if the information does not meet the classification criteria of the first class. In addition, the method comprises a step of applying a second classification technique to the information so as to assign the information to the second class if the information meets classification criteria of the second class, and to assign the information to the first class if the information does not meet the classification criteria of the second class. Moreover, the method comprises a step of updating the classification criteria of at least one of the two classification techniques in the event that the assignments of the information that are performed by the two classification techniques deviate from each other or in the event that a predefined number of mutually deviating assignments of information by the two classification techniques has been reached. Within this context, the first class and the second class differ from each another.

In accordance with the concept of the present invention, two classification techniques (e.g. two different, complementary or supplementary classification techniques) are applied to the information at the same time so as to classify said information into the first class or the second class, at least one the two classification techniques being updated by the two classification techniques in the event that the classifications of the information that are performed by the two classification techniques deviate from each other or in the event that a predefined number of mutually deviating classifications of information by the two classification techniques has been reached.

Further embodiments provide a classification processor for classifying information into a first class or a second class. The classification processor comprises two parallel classification stages and an updating stage. A first one of the two classification stages is configured to assign the information to the first class if the information meets classification criteria of the first class, and to assign the information to the second class if the information does not meet the classification criteria of the first class. A second one of the two classification stages is configured to assign the information to the second class if the information meets classification criteria of the second class, and to assign the information to the first class if the information does not meet the classification criteria of the second class, the first class and the second class being different from each another. The updating stage is configured to update the classification criteria at least of one of the two classification stages in the event that the assignments of the information that are performed by the two classification stages deviate from each other or in the event that a predefined number of mutually deviating assignments of information by the two classification stages has been reached.

Advantageous embodiments of the method of classifying information into a first class or a second class will be described below. However, the description which follows may also be applied to the classification processor.

In embodiments, the method may classify data. Of course, the method may also classify data of a data set, it being possible for the data of the data set to be classified individually by the method.

In embodiments, the first classification technique and the second classification technique may be mutually complementary. The first classification technique may be configured (e.g. suited or trained) to recognize information belonging to the first class, whereas the second classification technique may be configured (e.g. suited or trained) to recognize information belonging to the second class. Information which has not been recognized may be assigned to the respectively other class by the respective classification technique.

For example, the first classification technique and the second classification technique may differ, so that the first classification technique recognizes information belonging to the first class, and the second classification technique recognizes information belonging to the second class. For example, the first classification technique may be an outlier detection method, whereas the second classification technique may be a rule-based technique.

Of course, the first classification technique and the second classification technique may also be the same but differ in terms of the training, so that the first classification technique recognizes information belonging to the first class, and the second classification technique recognizes information belonging to the second class. For example, both classification techniques may be outlier detection methods or rule-based techniques.

In embodiments, the first classification technique may be an outlier detection method.

In this context, the first classification technique may be initialized, during an initialization phase, exclusively with information of the first class.

In embodiments, the second classification technique may be a rule-based technique.

During an initialization phase, the second classification technique may be initialized exclusively with information of the second class or with classification criteria based exclusively on known classification information of the second class.

In embodiments, at least one of the two classification techniques may be updated while using knowledge about actual class assignment of the information.

For example, in the event of mis-classification of the information by at least one of the two classification techniques, the respective classification technique or the classification criteria of the respective classification technique may be updated.

For example, if the first classification technique classifies the information incorrectly and the second classification technique classifies the information correctly, (only) the first classification technique, or the classification criteria of the first classification technique, may be updated. Likewise, (only) the second classification technique, or the classification criteria of the second classification technique, may be updated if the first classification technique classifies the information correctly and the second classification technique classifies the information incorrectly. Of course, it is also possible to update both classification techniques (or the classification criteria of the classification techniques) if both classification techniques or only one of the two classification techniques classifies the information incorrectly.

In embodiments, an updating step (e.g. during a training phase following an initialization phase) may comprise replacing at least some of a set of training information that is used for training the first classification technique if a predefined number of information which in actual fact should be assigned to the first class have been correctly assigned to the first class by the second classification technique but have been erroneously assigned to the second class by the first classification technique, so as to update the classification criteria of the first classification technique by renewed training (or applying) of the first classification technique on the updated set of training information.

In embodiments, an updating step (e.g. during a training phase following an initialization phase) may comprise replacing at least some of a set of training information of the second class that is used for training the second classification technique if a predefined number of information which in actual fact should be assigned to the second class have been correctly assigned to the second class by the first classification technique but have been erroneously assigned to the first class by the second classification technique, so as to update the classification criteria of the second classification technique by renewed training (or applying) of the second classification technique on the updated set of training information.

In embodiments, an updating step (e.g. during a training phase following an initialization phase) may comprise replacing at least some of a set of training information of the first class that is used for training the second classification technique if a predefined number of information which in actual fact should be assigned to the first class have been correctly assigned to the first class by the first classification technique but have been erroneously assigned to the second class by the second classification technique, so as to update the classification criteria of the second classification technique by renewed training (or applying) of the second classification technique on the updated set of training information.

In embodiments, an updating step (e.g. during a training phase following an initialization phase) may comprise replacing at least some of a set (e.g. set of test data) of training information that is used for training the first classification technique if a predefined number of information which in actual fact should be assigned to the second class have been correctly assigned to the second class by the second classification technique but have been erroneously assigned to the first class by the first classification technique, so as to update the classification criteria of the first classification technique by renewed training of the first classification technique with the aid of the updated set of test data.

### BRIEF DESCRIPTION OF THE DRAWINGS

Embodiments of the present invention will be detailed subsequently referring to the appended drawings, in which:

FIG. 1 shows a flow chart of a method of classifying information into a first class or a second class, in accordance with an embodiment;

FIG. 2a shows schematic views of a data set comprising data of a first class and data of a second class, as well as classification results of an area of data provided by a method comprising two classification techniques and, by comparison, by a method comprising only one classification technique, in accordance with a first classification step, for illustrating that when using the method comprising two classification techniques, less feedback may be needed than with the method comprising only one classification technique;

FIG. 2b shows schematic views of a data set comprising data of a first class and data of a second class, as well as classification results of an area of data provided by a method comprising two classification techniques and, by comparison, by a method comprising only one classification technique, in accordance with a second classification step, for illustrating that when using the method comprising two classification techniques, less feedback may be needed than with the method comprising only one classification technique;

FIG. 2c shows schematic views of a data set comprising data of a first class and data of a second class, as well as classification results of an area of data provided by a method comprising two classification techniques and, by comparison, by a method comprising only one classification technique, in accordance with a third classification step, for illustrating that when using the method comprising two classification techniques, less feedback may be needed than with the method comprising only one classification technique;

FIG. 3a shows schematic views of a data set comprising data of a first class and data of a second class, as well as classification results of an area of data provided by a method comprising two classification techniques and, by comparison, by a method comprising only one classification technique, in accordance with a first classification step, for illustrating that when using the method comprising two classification techniques, a higher level of accuracy is achieved than with the method comprising only one classification technique;

FIG. 3b shows schematic views of a data set comprising data of a first class and data of a second class, as well as classification results of an area of data provided by a method comprising two classification techniques and, by comparison, by a method comprising only one classification technique, in accordance with a second classification step, for illustrating that when using the method comprising two classification techniques, a higher level of accuracy is achieved than with the method comprising only one classification technique;

FIG. 3c shows schematic views of a data set comprising data of a first class and data of a second class, as well as classification results of an area of data provided by a method comprising two classification techniques and, by comparison, by a method comprising only one classification technique, in accordance with a third classification step, for illustrating that when using the method comprising two classification techniques, a higher level of accuracy is achieved than with the method comprising only one classification technique;

FIG. 4 shows a schematic view of a classification processor for classifying information into a first class or a second class, in accordance with an embodiment of the present invention.

### DETAILED DESCRIPTION OF THE INVENTION

In the below description of the embodiments of the present invention, elements which are identical or are identical in action will be provided with identical reference numerals in the figures, so that their descriptions are mutually exchangeable.

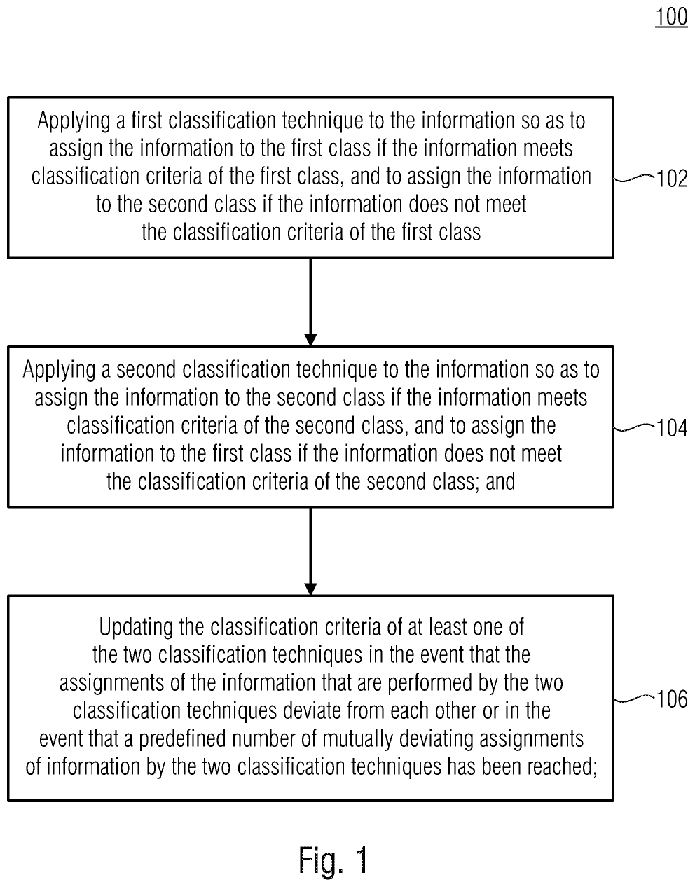

FIG. 1 shows a flow chart of a method 100 of classifying information into a first class or a second class. The method 100 includes a step 102 of applying a first classification technique to the information so as to assign the information to the first class if the information meets classification criteria of the first class, and to assign the information to the second class if the information does not meet the classification criteria of the first class. In addition, the method 100 comprises a step 106 of applying a second classification technique to the information so as to assign the information to the second class if the information meets classification criteria of the second class, and to assign the information to the first class if the information does not meet the classification criteria of the second class. Moreover, the method 100 comprises a step 108 of updating the classification criteria of at least one of the two classification techniques in the event that the assignments of the information that are performed by the two classification techniques deviate from each other or in the event that a predefined number of mutually deviating assignments of information by the two classification techniques has been reached. Within this context, the first class and the second class differ from each another.

In embodiments, the method 100 may classify data (e.g. information about an e-mail (sender, addressee, reference, etc.), a technical plant (temperature, pressure, valve positioning, etc.), or a disease pattern (symptoms, age, blood values, etc.)). Of course, the method 100 may also classify data (e.g. information about an e-mail (sender, addressee, reference, etc.), a technical plant (temperature, pressure, valve positioning, etc.), or a disease pattern (symptoms, age, blood values, etc.)) of a set of data (e.g. of a set of information about e-mails, technical plants or disease patterns), it being possible for the data of the data set to be individually classified by the method (e.g. each e-mail of the set of e-mails is classified individually).

In embodiments, the first classification technique and the second classification technique may be mutually complementary. The first classification technique may be configured (e.g. suited or trained) to recognize information belonging to the first class, whereas the second classification technique may be configured (e.g. suited or trained) to recognize information belonging to the second class. Information which has not been recognized may be assigned to the respectively other class by the respective classification technique.

For example, the first classification technique and the second classification technique may differ, so that the first classification technique recognizes information belonging to the first class, and the second classification technique recognizes information belonging to the second class. For example, the first classification technique may be an outlier detection method, whereas the second classification technique may be a rule-based technique.

Of course, the first classification technique and the second classification technique may also be the same but differ in terms of the training, so that the first classification technique recognizes information belonging to the first class, and the second classification technique recognizes information belonging to the second class. For example, both classification techniques may be outlier detection methods or rule-based techniques.

The method 100 may thus utilize a combination of, e.g., different classification techniques, e.g. machine-learning techniques; for example, expert knowledge may also be incorporated. By updating each technique by means of feedback during utilization, the level of accuracy may be increasingly improved during the course of the application, and the techniques may respond to changes in the framework conditions.

By way of example, two complementary approaches of implementing classification techniques (which distinguish between two classes) will be described below.

The first approach is based on knowledge about affiliation to class 1 (e.g. “normal data”, referred to as N data below), wherein any data which does not meet the criteria for class 1 will automatically be assigned to class 2 (e.g. “erroneous data”, referred to as F data below). Conversely, the second approach is based on knowledge about affiliation to class 2, wherein any data which does not meet the criteria for class 2 will automatically be assigned to class 1. In the typical cases of application (e.g. spam detection, tumor detection, error detection), the task is to filter out few data of class affiliation 2 (erroneous data) from a very large amount of data of class affiliation 1 (normal data). For this reason, the two above-mentioned approaches may clearly differ from each other: in the first case, a relatively large number of “erroneously positive” results are typically produced (class 1 is classified as class 2), whereas in the second case, a relative large number of “erroneously negative” results are produced (class 2 is classified as class 1). Depending on the case of application, one or the other disadvantage is easier to tolerate. Ideally, a classification technique should exhibit as low an erroneously positive rate as possible (high specificity) while exhibiting as low an erroneously negative rate as possible (high sensitivity).

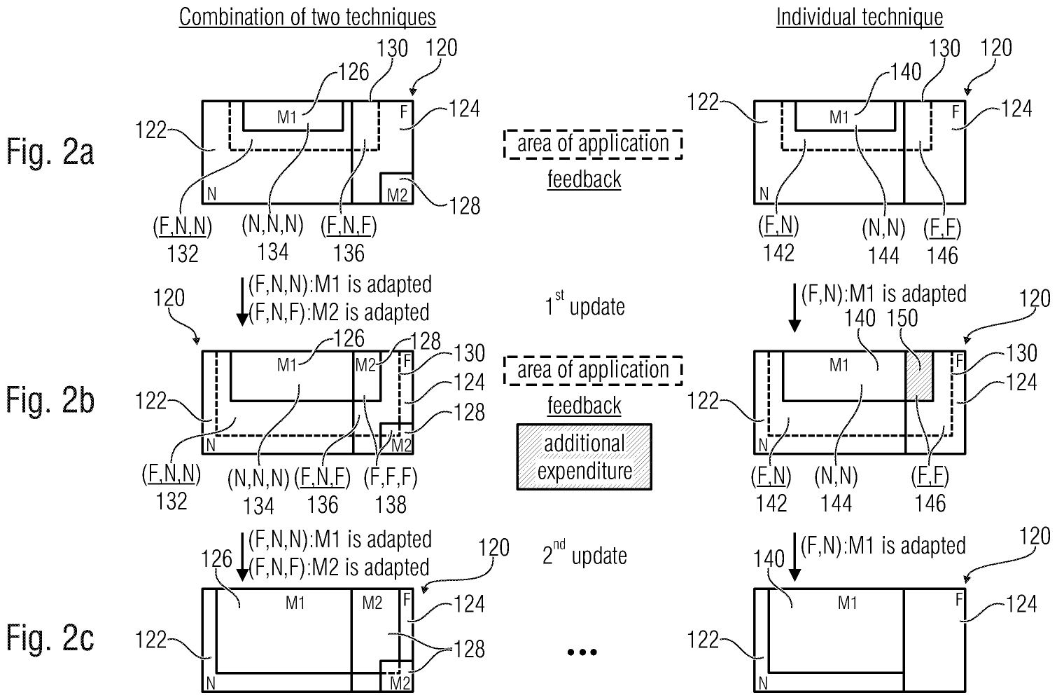

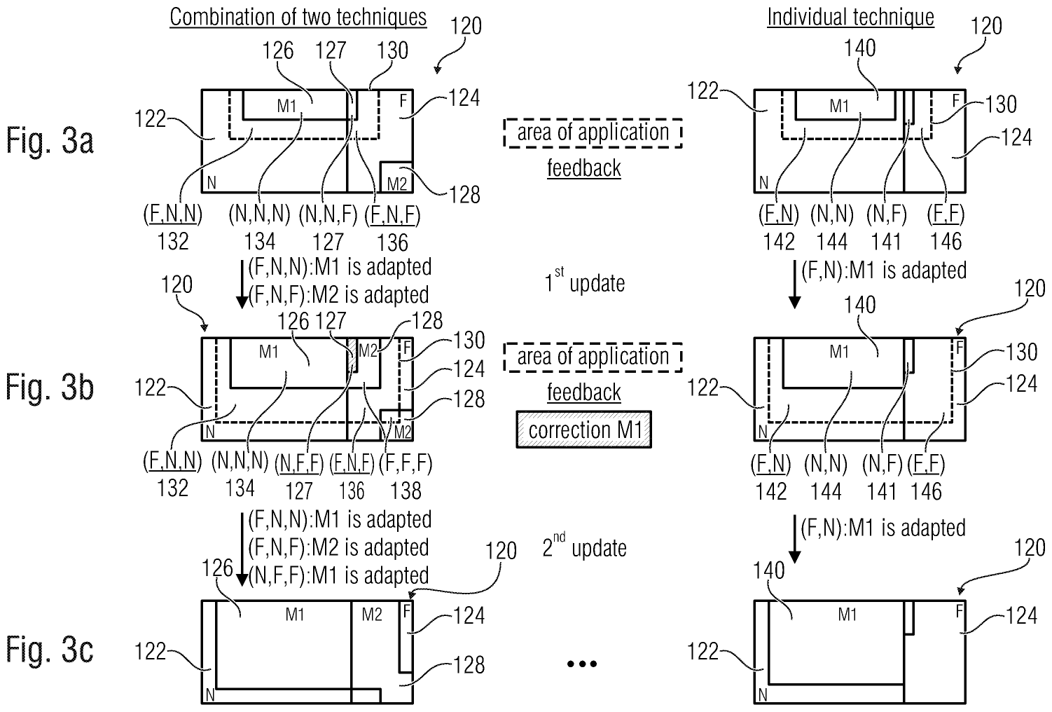

By way of example, the method 100 may also be based on a combination of the two above-described approaches. Optionally, knowledge about the class affiliations, which may be gained during the application, may be incorporated into the continuous improvements of the respective techniques (feedback). The advantage in combining two (complementary) techniques consists, as compared to using one single technique with a continuous update, in that less feedback may generally be needed in order to achieve a high level of accuracy, as will be described in detail below with reference to FIG. 2. In addition, combining two complementary techniques offers the possibility of identifying both erroneously positive and erroneously negative results of each individual technique and to reduce them by means of feedback, as will be described in more detail below with reference to FIG. 3.

On the left-hand side, FIG. 2a shows a schematic view of a data set 120 comprising data 122 of a first class (or data 122 of the first class, e.g. normal data (N)) and data 124 of a second class (or data 124 of the second class, e.g. erroneous data (F)), and shows, following an initialization phase, by way of example, an area 126 of the data set 120, which is recognized as being affiliated with (belonging to) the first class by the first classification technique (M1), and an area 128 of the data set 120, which is recognized as being affiliated with the second class by the second classification technique (M2), and an area (area of application) 130 of data of the data set 120, which has the method 100 comprising the two classification techniques applied to it.

In FIG. 2a (and also in FIGS. 2b and 2c), the classification results of the method 100 are indicated in brackets for the respective areas of the data set 120, wherein in the brackets, a first value indicates the classification result of the first classification technique, a second value indicates the classification result of the second classification technique, and a third value indicates the actual classification result (or target classification result). Those areas which are incorporated into the updating of the classification techniques by means of feedback are underlined.

As can be seen on the left-hand side of FIG. 2a, the area 132 of the data 122 of the first class (e.g. normal data) of the data set 120 which is located within the application area 130, but outside the area 126, of the data set 120 and is recognized as being affiliated with the first class by the first classification technique, is indicated by (F,N,N), i.e. the first classification technique assigns the data of the area 132 of the data set 120 to the second class of data (e.g. erroneous data), whereas the second classification technique assigns the data of the area 132 of the data set 120 to the first class of data (e.g. normal data). In actual fact, the data of this area 132 of the data set 120 should have been assigned to the first class of data (e.g. normal data), however, so that the classification result of the first classification technique is incorrect and so that, therefore, the first classification technique (or the classification criteria of the first classification technique) is to be adapted in a subsequent training step of the updating phase.

The area 134 of the data 122 of the first class (e.g. normal data) which is located within the application area 130 and within the area 126 of the data set 120 and is recognized as being affiliated with the first class of data (e.g. normal data) by the first classification technique, is indicated by (N,N,N), i.e. the first classification technique assigns the data of the area 134 of the data set 120 to the first class of data (e.g. normal data), and also the second classification technique assigns the data of the area 134 of the data set 120 to the first class of data (e.g. normal data). The data of the area 134 of the data set 120 should have been assigned to the first class, so that the classification results of both classification techniques are correct.

The area 136 of the data 124 of the second class (e.g. erroneous data) of the data set 120 which is located within the application area 130 is indicated by (F,N,F), i.e. the first classification technique assigns the data of the area 136 of the data set 120 to the second class of data (e.g. erroneous data), whereas the second classification technique assigns the data of the area 136 of the data set 120 to the first class of data (e.g. normal data). In actual fact, the data of the area 136 of the data set 120 should have been assigned to the second class of data (e.g. erroneous data), so that the classification result of the second classification technique is incorrect and so that, therefore, the second classification technique (or the classification criteria of the second classification technique) is to be adapted in a subsequent training step of the updating phase.

By way of comparison, the right-hand side in FIG. 2a shows a schematic view of the same data set 120 having the data 122 of the first class (e.g. normal data) and the data 124 of the second class (e.g. erroneous data), as well as, after an initialization phase, by way of example, an area 140 of the data set which is recognized as being affiliated with the first class of data (e.g. normal data) by a single classification technique (M1), and an area (application area) 130 of data of the data set which has a conventional method applied to it which comprises only one single classification technique.

In FIG. 2a (and also in FIGS. 2b and 2c), the classification results of the conventional method are indicated in brackets for the respective areas, a first value in the brackets indicating the classification result of the single classification technique, and a second value indicating the actual classification result (or target classification result).

For example, the area 142 of the data 122 of the first class (e.g. normal data) of the data set 120 which is located within the application area 130, but outside the area 140, of data and is recognized as being affiliated with the first class of data (e.g. normal data) by the single classification technique, is indicated by (F,N), i.e. the single classification technique assigns the data of the area 142 of the data set 120 to the second class (e.g. erroneous data). In actual fact, the data of the area 142 of the data set 120 should have been assigned to the first class of data (e.g. normal data), however, so that the classification result of the single classification technique is incorrect and so that, therefore, the single classification technique (or the classification criteria of the single classification technique) is to be adapted in a subsequent training step of the updating phase.

The area 144 of the data 122 of the first class (e.g. normal data) which is located within the application area 130 and within the area 140 of data and is recognized as being affiliated with the first class of data (e.g. normal data) by the single classification technique is indicated by (N,N), i.e. the single classification technique assigns the data of the area 144 of the data set 120 to the first class of data (e.g. normal data). The data of the area 144 of the data set 120 should have been assigned to the first class of data (e.g. normal data), so that the classification result of the single classification technique is correct.

The area 146 of the data 124 of the second class (e.g. erroneous data) of the data set 120 which is located within the application area 130 is indicated by (F,F), i.e. the single classification technique assigns the data of the area 146 of the data set 120 to the second class of data (e.g. erroneous data). The data of the area 136 of the data set 120 should have been assigned to the second class of data (e.g. erroneous data), so that the classification result of the single classification technique is correct.

On the left-hand side, FIG. 2b shows a schematic view of a data set 120 comprising the data 122 of the first class (e.g. normal data) and the data 124 of the second class (e.g. erroneous data), and shows, following a first training step of the updating phase, by way of example, an area 126 of data, which is now recognized as being affiliated with the first class of data (e.g. normal data) by the first classification technique, and an area 128 of data, which is now recognized as being affiliated with the second class of data (e.g. erroneous data) by the second classification technique, and an area (area of application) 130 of data of the data set 120, which has the method 100 applied to it.

As can be seen in FIG. 2b, the two classification techniques (or the classification criteria of the two classification techniques) were updated on the basis of the previous classification results. In detail, the first classification technique (or the classification criteria of the first classification technique) may be updated on the basis of the previously erroneously detected area 132 of the data set 120, so that the first classification technique now recognizes this area 132 of the data set 120 as being data of the first class 122. In addition, the second classification technique (or the classification criteria of the second classification technique) may be updated on the basis of the previously erroneously detected area 136 of the data set 120, so that the second classification technique now recognizes this area 136 of the data set 120 as being data of the second class 122. The area 126 of the data set 120, which now is recognized as being affiliated with the first class of data (e.g. normal data) by the first classification technique, thus has become larger as compared to FIG. 2a. Likewise, the area 128 of the data set 120, which is recognized as being affiliated with the second class of data (e.g. erroneous data) by the second classification technique, has become larger as compared to FIG. 2a.

Following the first updating step, the area 132 of the data 122 of the first class (e.g. normal data) of the data set 120 which is located within the application area 130, but outside the area 126, of data and is now recognized as being affiliated with the first class of data (e.g. normal data) by the first classification technique, is indicated by (F,N,N) in FIG. 2b, i.e. the first classification technique assigns the data of the area 132 of the data set 120 to the second class of data (e.g. erroneous data), whereas the second classification technique assigns the data of the area 132 of the data set 120 to the first class of data (e.g. normal data). In actual fact, the data of the area 132 of the data set 120 should have been assigned to the first class of data (e.g. normal data), however, so that the classification result of the first classification technique is incorrect and so that, therefore, the first classification technique (or the classification criteria of the first classification technique) is to be adapted in a subsequent training step of the updating phase.

The area 134 of the data 122 of the first class which is located within the application area 130 and within the area 126 of data and is now recognized as being affiliated with the first class of data (e.g. normal data) by the first classification technique, is indicated by (N,N,N), i.e. the first classification technique assigns the data of the area 134 of the data set 120 to the first class of data (e.g. normal data), and also the second classification technique assigns the data of the area 134 of the data set 120 to the first class of data (e.g. normal data). The data of the area 134 of the data set 120 should have been assigned to the first class of data (e.g. normal data), so that the classification results of both classification techniques are correct.

The area 136 of the data 124 of the second class (erroneous data) of the data set 120 which is located within the application area 130 and outside the areas 128 of the data which are now correctly recognized as being affiliated with the second class by the second classification technique, is indicated by (F,N,F), i.e. the first classification technique assigns the data of this area 136 of the data set 120 to the second class (erroneous data), whereas the second classification technique assigns the data of this area 136 of the data set 120 to the first class (normal data). In actual fact, the data of this area 136 of the data set 120 should have been assigned to the second class (erroneous data), so that the classification result of the second classification technique is incorrect and, therefore, the second classification technique (or the classification criteria of the second classification technique) is to be adapted in a subsequent training step of the updating phase.

The area 138 of the data of the second class (e.g. erroneous data) which is located within the application area 130 and within the areas 128 of the data which are now correctly recognized as being affiliated with the second class of data (e.g. normal data) by the second classification technique is indicated by (F,F,F), i.e. the first classification technique assigns the data of the area 138 of the data set 120 to the second class of data (e.g. erroneous data), and also the second classification technique assigns the data of the area 138 of the data set 120 to the second class of data (e.g. erroneous data). The data of the area 138 of the data set 120 should have been assigned to the second class of data, so that the classification results of both classification techniques are correct.

By way of comparison, the right-hand side of FIG. 2b shows a schematic view of the same data set 120 comprising the data 122 of the first class (e.g. normal data) and the data 124 of the second class (e.g. erroneous data), as well as, after a first training step of the training phase, by way of example, an area 140 of data which is now recognized as being affiliated with the first class of data (e.g. normal data) by the single classification technique, and an area (application area) 130 of data of the data set 120 which has the conventional method applied to it which comprises the single classification technique.

As can be seen on the right-hand side of FIG. 2b, the single classification technique was also adapted on the basis of the previously erroneously detected area 142 of the data set 120, so that the single classification technique now recognizes this area 142 of the data set 120 as being data of the first class 122. However, as compared to the method 100, this involves additional expenditure, which is marked as a gray (hatched) area 150 in FIG. 2b. In detail, the additional expenditure will make itself felt in the next updating step since there the area 146 (including 150) will be used for the update, whereas only 136 (without 128)—a smaller area—will be used on the left-hand side.

Following the first updating step, the area 142 of the data 122 of the first class (e.g. normal data) of the data set 120 which is located within the application area 130, but outside the area 140, of the data set 120 and is recognized as being affiliated with the first class (e.g. normal data) by the single classification technique, is indicated by (F,N), i.e. the single classification technique assigns the data of the area 142 of the data set 120 to the second class (e.g. erroneous data). In actual fact, however, the data of this area 142 of the data set 120 should have been assigned to the first class (e.g. normal data), however, so that the classification result of the single classification technique is incorrect and so that, therefore, the single classification technique (or the classification criteria of the single classification technique) is to be adapted in a subsequent training step of the updating phase.

The area 144 of the data 122 of the first class (e.g. normal data) which is located within the application area 130 and within the area 140 of the data set 120 and is recognized as being affiliated with the first class (e.g. normal data) by the single classification technique, is indicated by (N,N), i.e. the single classification technique assigns the data of this area 144 of the data set 120 to the first class (e.g. normal data). The data of this area 144 of the data set 120 should have been assigned to the first class (e.g. normal data), so that the classification result of the single classification technique is correct.

The area 146 of the data 124 of the second class (e.g. erroneous data) of the data set 120 which is located within the application area 130 is indicated by (F,F), i.e. the single classification technique assigns the data of this area 146 of the data set 120 to the second class of data (e.g. erroneous data). The data of this area 146 of the data set 120 should have been assigned to the second class of data (e.g. erroneous data), so that the classification result of the single classification technique is correct.

On the left-hand side, FIG. 2c shows a schematic view of the data set 120 comprising the data 122 (N) of the first class (e.g. normal data) and the data 124 (F) of the second class (e.g. erroneous data), as well as, in accordance with a second training step of the training phase, by way of example, an area 126 (M1) of data which is now recognized as being affiliated with the first class of data (e.g. normal data) by the first classification technique, and areas (M2) of data which are now recognized as being affiliated with the second class of data (e.g. erroneous data) by the second classification technique.

As can be seen in FIG. 2c, the two classification techniques (or the classification criteria of the two classification techniques) were updated on the basis of the previous classification results. In detail, the first classification technique (or the classification criteria of the first classification technique) may have been updated on the basis of the previously erroneously detected area 132 of the data set 120, so that the first classification technique now recognizes this area 132 of the data set 120 as being data of the first class 122. In addition, the second classification technique (or the classification criteria of the second classification technique) may have been updated on the basis of the previously erroneously detected area 136 of the data set 120, so that the second classification technique now recognizes this area 136 of the data set 120 as being data of the second class 122. The area 126 (M1) of the data set 120, which is recognized as being affiliated with the first class by the first classification technique, has thus become larger as compared to FIG. 2b. Likewise, the area 128 (M2) of the data set 120, which is recognized as being affiliated with the second class by the second classification technique, has become larger as compared to FIG. 2b.

By way of comparison, the right-hand side of FIG. 2c shows a schematic view of the same data set 120 comprising the data 122 of the first class (e.g. normal data) and the data 124 of the second class (e.g. erroneous data), as well as, after a second updating step, by way of example, an area 140 (M1) of the data set, which is now recognized as being affiliated with the first class by the single classification technique.

As can be seen on the right-hand side in FIG. 2c, the single classification technique was also adapted on the basis of the previously erroneously detected area 142 of the data set 120, so that the single classification technique now recognizes this area 142 of the data set 120 as being data of the first class 122.

In other words, FIGS. 2a to 2c show illustrations of the update mechanism by means of feedback when two techniques M1 and M2 are combined. The entire state space of the system may include, by way of example, a certain proportion of “erroneous” states (F) and “normal states” (N). At the beginning, a known N data set may be used for training M1, and possibly a known F data set or rules known from expert knowledge may be used for initializing M2. Application of the two techniques is performed on unknown data (area framed by broken lines) 130. If the classification of M1 does not match the classification of M2 (underlined areas 132, 136, 142, 146), additional information (e.g. expert knowledge) about a feedback may be used for adapting one or both techniques. In the course of the application and by means of continuous feedback, M1 and M2 may be steadily adapted; less and less feedback may be needed until, ideally, eventually the entire state space will be correctly classified.

As of the 2^{nd} update (second updating step), utilization of a combination of complementary techniques (left-hand side in FIGS. 2a to 2c) as compared to one single method (right-hand side in FIGS. 2a to 2c) will pay off since more feedback may be needed for one single technique (gray (hatched) area). With a single technique of the M1 type, feedback is obtained, within this context, for all F results since the number of erroneously positive results tends to be high. With one single technique of the M2 type (not depicted), feedback would be obtained for all N results since the number of erroneously negative results tends to be high.

As compared to FIGS. 2a to 2c, FIGS. 3a to 3c show a case wherein the first classification technique (M1) mis-classifies, by way of example, an area 127 of data of the second class (e.g. erroneous data) as being data of the first class (e.g. normal data).

As the classification result, (N,N,F) is indicated in FIG. 3a for this area 127, i.e. the first classification technique assigns the data of the area 127 to the first class of data (e.g. normal data), and also the second classification technique assigns the data of the area 127 to the first class of data (e.g. normal data). In actual fact, however, the data of the area 127 is data of the second class (e.g. erroneous data), so that the classification results of both classification techniques are wrong. Accordingly, both classification techniques (or the classification criteria of both classification techniques) are to be adapted in a subsequent (iterative) updating step.

In this case, the conventional classification technique yields (N,F) as a classification result for the area 141, i.e. the single classification technique assigns the data of the area 127 to the first class of data (e.g. normal data). In actual fact, however, the data of the area 127 is data of the second class (e.g. erroneous data), so that the classification result of the single classification technique is incorrect.

As can be seen on the left-hand side of FIG. 3b, (N,F,F) is indicated as the classification result for the area 127 after adaptation, i.e. the first classification technique assigns the data of the area 127 to the first class of data (e.g. normal data), whereas the second classification technique already assigns the data of the area 127 to the second class of data (e.g. erroneous data). Thus, the classification result of the first classification technique continues to be incorrect, so that the first classification technique (or the classification criteria of the first classification technique) is to be adapted in a subsequent updating step.

Also the conventional classification technique still provides (N,F) as the classification results in FIG. 3b for the area 141, i.e. the single classification technique assigns the data of the area 127 to the first class of data (e.g. normal data). In actual fact, however, the data of the area 127 is data of the second class (e.g. erroneous data), so that the classification result of the single classification technique is incorrect. No adaptation takes place (area is not underlined) since feedback is obtained for F results only.

In other words, FIGS. 3a to 3c show illustrations of the update mechanism by way of feedback. In detail, FIGS. 3a to 3c show a comparison of the approach for a combination of two complementary techniques as compared to a single technique. In contrast to FIGS. 2a to 2c, here the case is depicted where M1 generates erroneously negative results. Correction of M1 is not possible when a single technique is used (right-hand side in FIGS. 3a to 3c). However, combining two complementary techniques enables corresponding adaptation to be performed (see FIG. 3c). By analogy, M2 may be corrected, in case M2 generates erroneously positive results.

Exemplary implementations of the first classification technique and of the second classification technique will be described below.

As the first classification technique (technique 1 (M1)), a technique for “outlier detection” may be used. This includes various techniques of data mining and machine learning such as multiple linear regression, clustering (cluster formation), qualitative models, etc. What can be decisive with this technique is that it is trained on the basis of a set of training data which includes exclusively class 1 (N data). If need be, the parameters for the technique used may be adjusted by means of a set of test data, which also contains data of class 2 (F data).

As the second classification technique (technique 2 (M2)), a rule-based technique may be used; the rules may be formulated, e.g., in a manual manner (on the basis of expert knowledge), or a (binary) classification technique may be used, such as support vector machines, decision trees, logistic regression, neuronal networks, etc. Even a combined set of expert rules and automatically generated rules/classifiers is possible. A set of training data for M2 may contain both F data and N data. As a technique of automated extraction of rules from a corresponding set of training data, decision trees, or decision forests, may be used. What may be decisive for utilizing expert rules is that they may be formulated on the basis of known errors (affiliation with class 2).

In the following, the (iterative or continuous) updating process of the method 100 of classifying data will be described in more detail.

In a first step, a set of training data may be used which contains only N data. The first classification technique (M1) may be trained on this set of training data. Any parameters that may be used for M1 may either be initially estimated or be determined by means of cross validation.

In a second step, errors which may possibly already be known may be formulated as rules. These may then form the starting point for the second classification technique (M2). Otherwise, a default may be used for M2 which classifies each data point as an N data point.

In a third step, M1 and M2 may be applied in parallel to an unknown data set (which is to be classified). For each data point of the unknown data set, M1 and M2 each may provide independent classification (N or F). The number of deviating results, i.e. where classification by M1≠classification by M2, is determined.

In a fourth step, said results may be compared, as soon as the number of mutually deviating results exceed a certain specified threshold, to the actual classification (E), e.g. by an expert, user of the system or by any other source. Subsequently, M1 and M2 may be adapted in the following manner:

If the number of results with (M1=F,M2=N,E=N) exceeds a given number, M1 can be adapted (set of training data is adapted), i.e. a given number of randomly drawn data points from the set of training data for M1 may be replaced by the corresponding number of randomly selected data points from the (M1=F,M2=N,E=N) results.

If the number of results with (M1=F,M2=N,E=F) exceeds a given number, M2 can be adapted (set of training data is adapted), i.e. a given number of randomly drawn data points from the F data of the set of training data for M2 may be replaced by the corresponding number of randomly selected data points from the (M1=F,M2=N,E=F) results. If the set of training data for M2 so far contains only N data, a given number of randomly selected data points from the (M1=F,M2=N,E=F) results may be added to the existing set of training data for M2.

If the number of results with (M1=N,M2=F,E=N) exceeds a given number, M2 can be adapted (set of training data is adapted), i.e. a given number of randomly drawn data points from the N data of the set of training data for M2 are replaced by the corresponding number of randomly selected data points from the (M1=N,M2=F,E=N) results. If the set of training data for M2 does not yet exist, a given number of randomly selected data points from the (M1=N,M2=F,E=N) results may be used as an initial set of training data for M2.

If the number of results with (M1=N,M2=F,E=F) exceeds a given number, M1 can be adapted (parameters are adapted), i.e. a given number of randomly drawn data points from the F data of the set of test data for M1 may be replaced by the corresponding number of randomly selected data points from the (M1=N,M2=F,E=F) results. If the set of test data for M1 does not yet exist, a given number of randomly selected data points from the (M1=N,M2=F,E=F) results may be used as an initial set of test data for M1. The optimum parameters may be determined by means of cross validation while taking into account the set of test data.

In a fifth step, M1 and M2 may be trained on new sets of training data, or with new parameters.

In a sixth step, steps three to six are repeated.

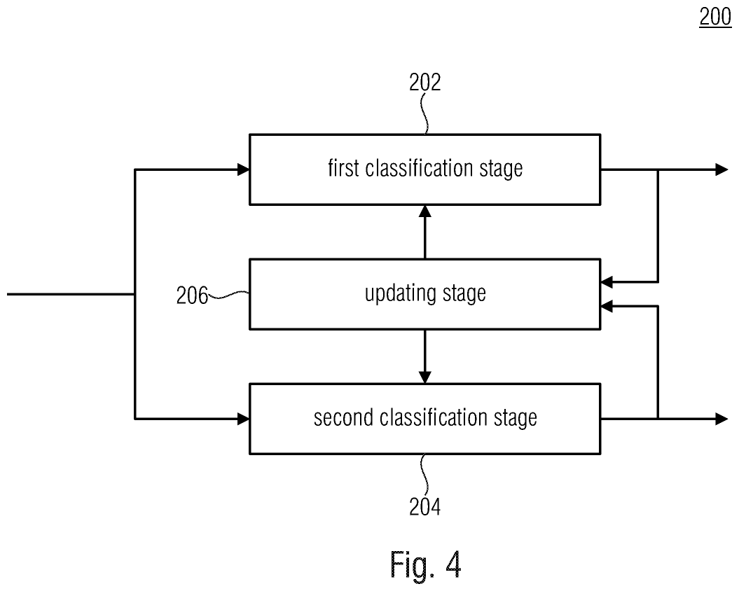

FIG. 4 shows a schematic view of a classification processor 200 for classifying information into a first class or a second class, in accordance with an embodiment of the present invention. The classification processor 200 comprises two parallel classification stages 202 and 204 and an updating stage 206. A first classification stage 202 of the two classification stages 202 and 204 is configured to assign the information to the first class if the information meets classification criteria of the first class, and to assign the information to the second class if the information does not meet the classification criteria of the first class. A second classification stage 204 of the two classification stages is configured to assign the information to the second class if the information meets classification criteria of the second class, and to assign the information to the first class if the information does not meet the classification criteria of the second class, the first class and the second class being different from each another. The updating stage is configured to update the classification criteria at least of one of the two classification stages in the event that the assignments of the information that are performed by the two classification stages deviate from each other or in the event that a predefined number of mutually deviating assignments of information by the two classification stages has been reached.

By combining different, complementary techniques, embodiments provide a classification method (or a classification processor, or classifier) having a high degree of robustness and accuracy. In addition, continuous feedback enables constant improvement in accuracy in the course of the application, and adaptation to modified outer circumstances, or detection of newly occurring errors. The decisive advantage of using a combination of two complementary techniques consists in that the proportion of feedback operations that may be performed is smaller than with one single technique and will decrease in the course of the application.

Embodiments of the present invention may be used for spam filtering, tumor detection, identification of credit card fraud and error detection in technical plants.

In embodiments, the information classified by the method 100 may be sensor data (or sensor values), e.g. of a set of sensor data (or sensor values).

In embodiments, the sensor data may be detected by one or more external sensors (e.g. a technical plant).

In embodiments, the sensor data may be temperatures, pressures, volumetric flow rates, or actuating signals, for example.

In embodiments, a first signal may be output when the information was assigned to the first class by both classification techniques. For example, the information of the first class may be normal information (e.g. sensor data (or measured sensor values) which lies within a predefined sensor datan area (or target measured-value area)); the first signal may indicate a proper state of operation (e.g. of the technical plant)).

In embodiments, a second signal may be output when the information was assigned to the second class by both classification techniques. For example, the information of the second class may be erroneous information (e.g. sensor data (or measured sensor values) which lies outside a predefined sensor datan area (or target measured-value area)); the second signal may indicate a faulty state of operation (e.g. of the technical plant)).

In embodiments, a third signal may be output when the information was assigned to different classes by the classification techniques.

In embodiments, the method may be used for detecting errors in technical plants (e.g. service plants) and to report them.

In embodiments, time-series data of sensors (for example temperatures, pressures, volumetric flow rates, actuating signals) may be used as input data for the method.

In embodiments, all or selected sensor data assigned to a point in time may be considered as being a data point.

In embodiments, each data point may be classified as normal, as an error or as unknown by the method.

In embodiments, classification of a data point as an error may indicate errors in the operation of the technical plants, so that said errors may be eliminated.

In embodiments, classification as unknown may occur when the complementary techniques underlying the method suggest different classifications.

In embodiments, data points with the classification of “unknown” may be classified while using further (external) information, such as knowledge about actual class assignment, for example.

In embodiments, actual classification may be used for updating and, therefore, improving the techniques underlying the method. For example, the information about actual classification may be provided by a user (e.g. a facility manager). However, it shall be noted that updating of the classification criteria is performed by an algorithm rather than by the user.

In embodiments, the number of data points classified as unknown may be reduced in the course of the application, the number of mis-classified data points also decreasing.

In embodiments, the method enables adapting the classification to changing framework conditions (e.g. switching from heating to cooling) and detection of new types of errors.

In embodiments, a data point of the “unknown” class without any further (external) information (e.g. provided by a user) may either be regarded in any case as an error or may be regarded as normal in any case.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described in connection with or as a method step also represent a description of a corresponding block or detail or feature of a corresponding device. Some or all of the method steps may be performed by a hardware device (or while using a hardware device) such as a microprocessor, a programmable computer or an electronic circuit, for example. In some embodiments, some or several of the most important method steps may be performed by such a device.

A signal encoded in accordance with the invention, such as an audio signal or a video signal or a carrier stream signal, may be stored on a digital storage medium or may be transmitted on a transmission medium such as a wireless transmission medium or a wired transmission medium, e.g. the internet.

The audio signal encoded in accordance with the invention may be stored on a digital storage medium or may be transmitted on a transmission medium such as a wireless transmission medium or a wired transmission medium, e.g. the internet.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded. The data carrier, the digital storage medium or the computer-readable medium are typically concrete and/or non-transitory and/or non-transient.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example.

The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU) or a graphics card (GPU), or may be a hardware specific to the method, such as an ASIC.

The devices described herein may be implemented, e.g., while using a hardware apparatus or while using a computer or while using a combination of a hardware apparatus and a computer.

The devices described herein or any components of the devices described herein may be implemented, at least partly, in hardware or in software (computer program).

The methods described herein may be implemented, e.g., while using a hardware apparatus or while using a computer or while using a combination of a hardware apparatus and a computer.

The methods described herein or any components of the devices described herein may be executed, at least partly, by hardware or by software.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Computer-implemented method of classifying information into a first class or a second class, the method comprising:
applying a first classification technique to the information so as to assign the information to the first class if the information meets classification criteria of the first class, and to assign the information to the second class if the information does not meet the classification criteria of the first class;
applying a second classification technique to the information so as to assign the information to the second class if the information meets classification criteria of the second class, and to assign the information to the first class if the information does not meet the classification criteria of the second class; and
updating the classification criteria of at least one of the two classification techniques in the event that the assignments of the information that are performed by the two classification techniques deviate from each other or in the event that a predefined number of mutually deviating assignments of information by the two classification techniques has been reached;
wherein the first class and the second class differ from each another;
wherein the method is used for error detection in technical plants;
wherein the information classified by the method is sensor data;
wherein the method further comprises:
outputting a first signal if the information has been assigned to the first class by both classification techniques;
outputting a second signal if the information has been assigned to the second class by both classification techniques; and
outputting a third signal if the information has been assigned to different classes by the classification techniques.

2. Computer-implemented method as claimed in claim 1,
wherein the first signal indicates a proper state of operation of the technical plant;
wherein the second signal indicates a faulty state of operation of the technical plant.

3. Computer-implemented method as claimed in claim 1, wherein the first classification technique and the second classification technique are mutually complementary.

4. Computer-implemented method as claimed in claim 1, wherein at least one of the two classification techniques is updated while using knowledge about actual class assignment of the information.

5. Computer-implemented method as claimed in claim 1, wherein the information is data; or wherein the information is data of a data set, the data of the data set being individually classified by the method.

6. Computer-implemented method as claimed in claim 1, wherein the first classification technique is an outlier detection technique.

7. Computer-implemented method as claimed in claim 6, the method comprising:
initializing the first classification technique exclusively with information of the first class during an initialization phase.

8. Computer-implemented method as claimed in claim 1, wherein the second classification technique is a rule-based technique.

9. Computer-implemented method as claimed in claim 8, the method comprising:
initializing, during an initialization phase, the second classification technique exclusively with information of the second class or with classification criteria based exclusively on known classification information of the second class.

10. Computer-implemented method as claimed in claim 1, wherein during a training phase following an initialization phase, at least some of a set of training information that is used for training the first classification technique is replaced if a predefined number of information which in actual fact should be assigned to the first class have been correctly assigned to the first class by the second classification technique but have been erroneously assigned to the second class by the first classification technique, so as to update the classification criteria of the first classification technique by renewed application of the first classification technique to the replaced set of training information.

11. Computer-implemented method as claimed in claim 1, wherein during a training phase following an initialization phase, at least some of a set of training information of the second class that is used for training the second classification technique is replaced if a predefined number of information which in actual fact should be assigned to the second class have been correctly assigned to the second class by the first classification technique but have been erroneously assigned to the first class by the second classification technique, so as to update the classification criteria of the second classification technique by renewed application of the second classification technique to the replaced set of training information.

12. Computer-implemented method as claimed in claim 1, wherein during a training phase following an initialization phase, at least some of a set of training information of the first class that is used for training the second classification technique is replaced if a predefined number of information which in actual fact should be assigned to the first class have been correctly assigned to the first class by the first classification technique but have been erroneously assigned to the second class by the second classification technique, so as to update the classification criteria of the second classification technique by renewed application of the second classification technique to the replaced set of training information.

13. Computer-implemented method as claimed in claim 1, wherein during a training phase following an initialization phase, at least some of a set of training information that is used for training the first classification technique is replaced if a predefined number of information which in actual fact should be assigned to the second class have been correctly assigned to the second class by the second classification technique but have been erroneously assigned to the first class by the first classification technique, so as to update the classification criteria of the first classification technique by renewed training of the first classification technique with the aid of the updated set of test data.

14. Classification processor for classifying information into a first class or a second class, the classification processor comprising:
two parallel classification stages, a first classification stage of the two classification stages being configured to assign the information to the first class if the information meets classification criteria of the first class, and to assign the information to the second class if the information does not meet the classification criteria of the first class, a second classification stage of the two classification stages being configured to assign the information to the second class if the information meets classification criteria of the second class, and to assign the information to the first class if the information does not meet the classification criteria of the second class, the first class and the second class being different from each another; and
an updating stage configured to update the classification criteria at least of one of the two classification stages in the event that the assignments of the information that are performed by the two classification stages deviate from each other or in the event that a predefined number of mutually deviating assignments of information by the two classification stages has been reached,
wherein the information classified by the classification processor is sensor data;
wherein the classification processor is configured to output a first signal if the information has been assigned to the first class by both classification techniques;
wherein the classification processor is configured to output a second signal if the information has been assigned to the second class by both classification techniques; and
wherein the classification processor is configured to output a third signal if the information has been assigned to different classes by both classification techniques.

15. Classification processor as claimed in claim 14, the classification processor being used for error detection in technical plants.
